(19) United States
(12) Patent Application Publication
(10) Pub. No.: US 2010/0218655 A1
(43) Pub. Date: Sep. 2, 2010

(54) CURVED RECIPROCATING SAW BLADE FOR CUTTING CIRCLES, HOLES AND/OR ARCHES

(76) Inventors: John Donald Gillette, Bonita Springs, FL (US); Gavin John Gillette, Bonita Springs, FL (US)

Correspondence Address: GAVIN GILLETTE, 25100 BERNWOOD DR, BONITA SPRINGS, FL, 34135, US

(21) Appl. No.: 12/710,273

(22) Filed: Feb. 22, 2010

Related U.S. Application Data
(60) Provisional application No. 61/155,991, filed on Feb. 27, 2009.

(51) Int. Cl. B23D 61/18; B26D 3/10

(52) U.S. Cl. 83/56; 83/835

(57) ABSTRACT

A reciprocating saw blade having a shank with a longitudinal axis which extends from one end of the blade to the other end of the blade and a transverse axis which extends across the width of the blade. A cutting edge is located along one or both longitudinal edges of the shank of the blade, a concave side wall extends along the transverse axis of one side of the blade, a convex side wall extends along the transverse axis of the other side of the blade and the curvature is around the longitudinal axis.

### REFERENCE TO RELATED APPLICATIONS

This patent application claims the benefit of U.S. Provisional Application No. 61/155,991 filed on Feb. 27, 2009, the disclosure of which is incorporated herein in its entirety by reference.

### BACKGROUND OF THE INVENTION

1. Field of the Invention

The present invention relates to apparatus and method for using a reciprocation blade having a concave surface on one side of the blade and a convex surface of the other side of the blade to make a radius cut in a material.

2. Description of Related Art

Apparatus and methods for cutting material is known in the prior art. More specifically, by way of example, U.S. PreGrant Pub. No. 2006/0130628 to Rompel, et al. discloses a reciprocating saw which has a tooth form that decreases the cutting time of the saw blade and extends the life of the saw blade. The tooth height is longer than prior art metal cutting reciprocating saws, and has a larger gullet and a tooth rake angle that remains substantially constant during the life of the saw blade.

U.S. Pat. No. 6,782,781 to Rack discloses a saw blade for a reciprocating saw having first and second longitudinal edges and first and second opposite ends. The saw blade is provided at its first end with an attachment element for attaching the blade to a power unit. First and second longitudinal edges of the blade have teeth which are raked towards the first end of the saw blade.

U.S. Pat. No. 5,855,157 to Okamura, et al. discloses a saw blade that prevents “fluff” or “return” of fibers from occurring when used to cut wood to eliminate finishing work. The blade has a combination of cutting teeth and biting teeth where the biting teeth are located either above or in front of each cutting tooth and have a smaller width than the cutting teeth.

U.S. Pat. No. 5,139,064 to Nunweiler discloses a number of removably mounted saw teeth on a tree-felling saw head which has a body portion with a lead cutter and a trailing primary cutter separated by a throat. The combined lead cutters function to cut a narrow side wall kerf on each side of a larger principal kerf together with corresponding inside corners of the larger kerf. The remainder of the larger kerf is then cut out by the following primary cutters to form a square cut end. As the cut progresses, the combined primary cutters separate the longitudinal fibers of the tree at the square cut end without double cutting the fibers.

U.S. Pat. No. 3,842,501 to Honma discloses a knife that has a cutting edge that cannot make direct contact with a cutting board. The knife has a series of alternately spaced projection that are spaced along the cutting edge and that extend beyond the cutting edge to prevent the cutting edge of the knife from touching the cutting board.

U.S. Pat. No. 3,314,456 to Craven discloses a toothed cutting edge and an edge that has no teeth. The cutting portion of the blade is provided with concave side walls formed by longitudinally rolling the cutting portion of the blade. The concave side walls of the cutting portion extend acutely with a radius continuously across the blade from the tips of the teeth to the other side edge of the blade.

U.S. PreGrant Publication No. 2008/0201964 to Camargo; et al. discloses a saw blade having a concave shaped sawing edge and two oppositely-directed sets of teeth. During reciprocation of the blade, a first set of the teeth cut during a first stroke direction and the second set of teeth cut during a second stroke direction.

### SUMMARY OF THE INVENTION

In an exemplary embodiment of the present invention, there is disclosed a reciprocating saw blade comprising:
a shank having a longitudinal axis which extends from one end of the blade to the other end of the blade and a transverse axis which extends across the width of the blade;
a cutting edge located along one or both longitudinal edges of the shank of the blade;
a concave side wall which extends along the transverse axis of one side of the blade and around the longitudinal axis; and
a convex side wall which extends along the transverse axis of the other side of the blade and around the longitudinal axis.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of a reciprocating saw blade having a concave surface on one side and a convex surface on the other side of the blade in accordance with the principles of the invention;

FIG. 2 is a perspective view of the reciprocating saw blade of FIG. 1;

FIG. 3 is a sectional view along line A-A of FIG. 2 looking toward the front or leading end of a reciprocating saw blade configured for making a cut along a constant or varying radius;

FIG. 4 is a sectional view along line A-A of FIG. 2 looking toward the front or leading end of a reciprocating saw blade configured for making a cut along a smaller constant or varying radius; and

FIG. 5 is a sectional view along line A-A of FIG. 2 looking toward the front or leading end of a reciprocating saw blade configured for making a cut along an even smaller constant or varying radius.

### DESCRIPTION OF THE PREFERRED EMBODIMENT

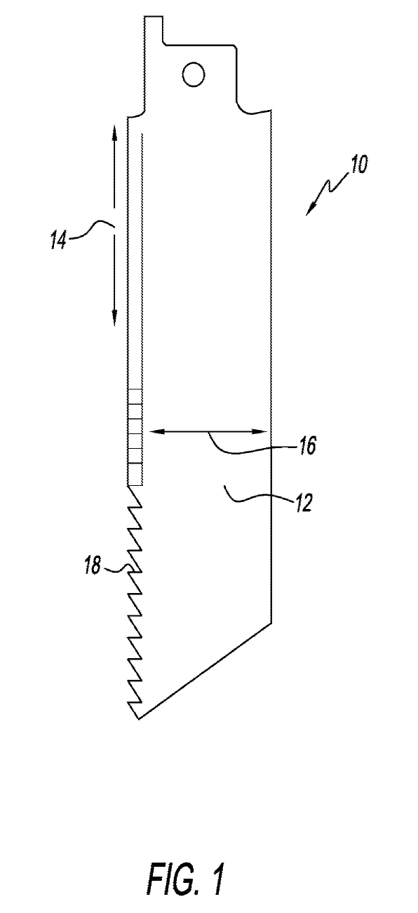

Referring to FIG. 1, there is shown a side view of a reciprocating saw blade having a concave surface on one side and a convex surface on the other side of the blade in accordance with the principles of the invention.

Existing flat, straight blades cannot be used to cut aggressive curves. When attempting to make a cut along a radius, the rear edge of a flat blade typically contacts the outer edge of the cut, which not only prevents the blade from following a desired radius cut, but also creates high friction heat levels between the blade and the material being cut. The result is that the blade or the teeth on the blade may break, warp or bend, and the material being cut can be damaged by the high heat generated by the friction, and the desired cut is not obtainable.

The problem with prior art reciprocating saw blades is that a straight, flat blade cannot conform to and/or accommodate the required or desired curve or radius as a radius cut is being attempted.

A conventional reciprocating saw apparatus has a housing that contains an electric motor and a mechanism that converts the rotary motion of the electric motor to a reciprocating linear movement of a blade attachment member for receiving a saw blade. One end of the blade has a tang and an opening for receiving a locking pin or other attachment element for securing the blade to the saw. The other end of the blade, typically has an inclined, transverse edge that extends from one side edge of the blade to the other and forms a point at the toothed edge of the blade. Activation of the reciprocating saw causes continuous longitudinal reciprocating motion of the blade toward and away from the material being cut.

Looking at FIG. 1, there is shown a reciprocating saw blade 10 having a substantially rigid shank 12, a longitudinal axis 14, and a transverse axis 16. The saw blade can have a length which varies from four inches or less to ten inches or more, a width that can be from one quarter of an inch to an inch, or more or less with abrasive or cutting means 18 located along at least one longitudinal edge of the blade, and a thickness of about three sixty fourths of an inch, or more or less. The blade is straight along its longitudinal axis 14, curved around its longitudinal axis 14, and is curved along its transverse axis 16.

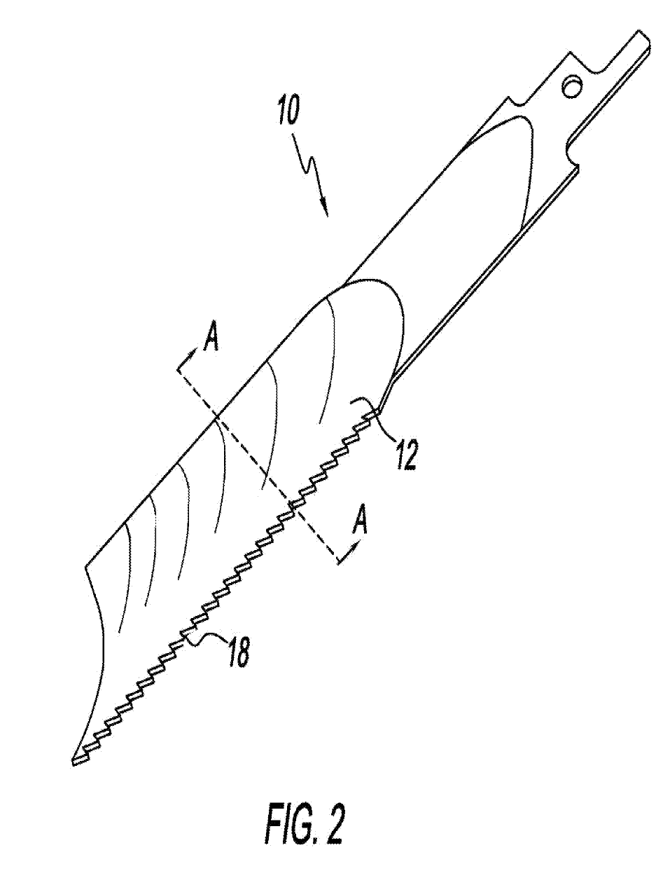

Referring to FIG. 2, there is shown a perspective view of the reciprocating saw blade of FIG. 1 where the concave side of the blade along the transverse axis is facing the viewer. The saw blade may be made from any suitable rigid or semi rigid material such as, for example, hardened metals and the like. The curvature of the blade along the transverse axis can be of any desired radius which is suitable for the particular cut or task at hand.

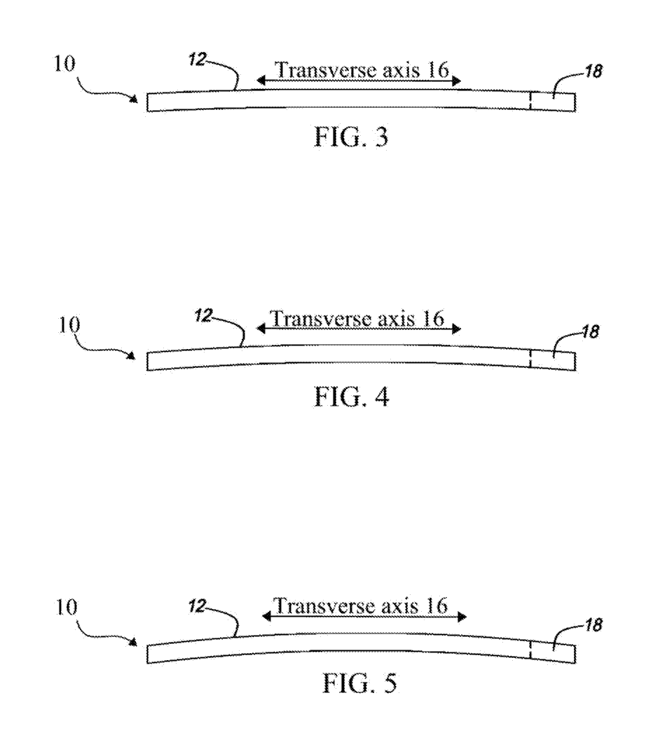

In an embodiment of the invention shown in FIG. 3, there is disclosed a sectional view along line A-A of FIG. 2 looking toward the front or leading end of the shaft 12 of reciprocating saw blade 10 configured for making a cut along a radius of nine inches. The concave side of saw blade 10 has a radius of curvature of nine inches and the convex side of the saw blade has a radius of curvature of nine inches plus the thickness of the blade.

The end of the blade that is attached to the reciprocating blade attaching member includes attaching means of, for example, one or more apertures such as pilot holes, protrusions, hooks, a tang and/or handles. The attaching means can be of the same width, smaller, or larger than the width of the blade. The reciprocating blade may be attached at one end to a powered saw body, assembly, or machine, such as electric reciprocating saw, or the reciprocating blade may be connected to a handle or other means and operated manually by a person

The cutting means 18 on the edge of the blade can include but not limited to various abrasive means such as cutting teeth for cutting through objects or materials, and/or industrial abrasive material or particles, such as diamond or carbide fragments similar to mediums used for cutting masonry and ceramic tile products or those used in sandpapers for sanding surfaces.

The blade may be made as a single component reciprocating saw blade of hardened steel using existing or new techniques, with the feature of the curvature of the blade along the transverse axis as here disclosed to provide a new improved apparatus for cutting material along a given or desired radius.

The radius of the curvature of the sides of the blade will depend on the dimension of the radius being cut. The curvature feature may be added during the manufacturing process through existing or new techniques. The end of the blade that is attached to the reciprocating attaching member can remain flat to allow existing attachment methods as typically designed to be used. Thus, the curvature of the blade will not interfere with the attachment method to a conventional reciprocating saw.

The curvatures on the sides of the blade are selected to allow the blade to cut a desired radius. Blades can be produced with various radii for making radial cuts of varying dimensions. The curve of the blade allows it to follow a desired curve very simply and naturally. The blade having a curve along its transverse axis as is here disclosed eliminates fatigue, damaged blades, multiple pilot holes, unsightly cuts, risk of operator injury, and other various shortcomings by eliminating the requirement that the person must force a flat or straight blade into a curve that it is not designed to follow.

The blade can be made using existing or future flat blade production methods with one or more additions. For example, a die, press, or other steps would be added to the production line to produce the desired curve. Such a step would most likely, but not necessarily take place prior to material hardening, if any.

The blade may be installed in any reciprocating saw to allow the operator to make circular or curved cuts. A person accustomed to using saws and devices with flat blades would typically be qualified to operate the saw with the new curved blade.

In another embodiment of the invention there is disclosed in FIG. 4 a sectional view along line A-A of FIG. 2 looking toward the front or leading end of the shaft 12 of reciprocating saw blade 10 configured for making a cut along a radius of five inches. The concave side of saw blade 10 has a radius of curvature of five inches and the convex side of the saw blade has a radius of curvature of five inches plus the thickness of the blade. Except for the different radius of curvature of the blade, the embodiment of FIG. 4 includes all of the features and advantages noted above for the embodiment of FIG. 3.

In still another embodiment of the invention there is disclosed in FIG. 5 a sectional view along line A-A of FIG. 2 looking toward the front or leading end of the shaft 12 of reciprocating saw blade 10 configured for making a cut along a radius of three inches. The concave side of saw blade 10 has a radius of curvature of three inches and the convex side of the saw blade has a radius of curvature of three inches plus the thickness of the blade. Except for the different radius of curvature of the blade, the embodiment of FIG. 5 includes all of the features and advantages noted above for the embodiment of FIG. 3.

In other embodiments of the invention, it is understood that the radius of curvature of the blade can vary to make a cut along nearly unlimited radii.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. It should be recognized that modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

What is claimed is:

1. A reciprocating saw blade comprising:
a shank having a longitudinal axis which extends from one end of the blade to the other end of the blade and a transverse axis which extends across the width of the blade;
a cutting edge located along one or both longitudinal edges of the shank of the blade;
a concave side wall which extends along the transverse axis on one side of the blade and around the longitudinal axis; and
a convex side wall which extends along the transverse axis on the other side of the blade and around the longitudinal axis.

2. The reciprocating saw blade of claim 1 wherein the concave side wall extends along the full length of the transverse axis on one side of the blade; and the convex side wall extends along the full length of the transverse axis on the other side of the blade.

3. The reciprocating saw blade of claim 1 wherein the shank has a generally rectangular cross section of generally uniform thickness.

4. The reciprocating saw blade of claim 3 wherein the concave side wall has a first radius of curvature and the convex side wall has a second radius of curvature equal to the first radius of curvature plus the thickness of the shank.

5. The reciprocating saw blade of claim 4 wherein the concave side wall and the convex side wall extend longitudinally along the length of the cutting edge.

6. The reciprocating saw blade of claim 5 wherein one end of the shank has attachment means for attaching the blade to a reciprocating member for providing a reciprocating motion to the blade.

7. The reciprocating saw blade of claim 6 wherein the reciprocating member is an electrically operated reciprocating saw.

8. The reciprocating saw blade of claim 6 wherein the concave side and the convex side of the blade have a desired curvature for cutting material along a desired radius.

9. The reciprocating saw blade of claim 8 wherein the cutting edge has teeth.

10. The reciprocating saw blade of claim 8 wherein the cutting edge includes industrial abrasive material or particles.

11. A method for making a radius cut in a material using a reciprocating saw blade comprises:
providing a shank having a longitudinal axis which extends from one end of the blade to the other end of the blade and a transverse axis which extends across the width of the blade;
locating a cutting edge along one or both longitudinal edges of the shank of the blade;
providing a concave side wall which extends along the transverse axis on one side of the blade; and
providing a convex side wall which extends along the transverse axis of the other side of the blade.

12. The method of claim 11 wherein the concave side wall extends along the transverse axis the full width of one side of the blade; and the convex side wall extends along the transverse axis the full width of the other side of the blade.

13. The method of claim 11 wherein the shank has a generally rectangular cross section of generally uniform thickness.

14. The method of claim 13 wherein the concave side wall has a first radius of curvature and the convex side wall has a second radius of curvature equal to the first radius of curvature plus the thickness of the shank.

15. The method of claim 14 wherein the concave side wall and the convex side wall extend longitudinally along the length of the cutting edge.

16. The method of claim 15 wherein one end of the shank has attachment means for attaching the blade to a reciprocating member for providing a reciprocating motion to the blade.

17. The method of claim 16 wherein the reciprocating member is an electrically operated reciprocating saw.

18. The method of claim 16 wherein the concave side and the convex side of the blade have a desired curvature for cutting material along a desired radius of between one inch and fifty inches.

19. The method of claim 18 wherein the cutting edge has teeth.

20. The method of claim 18 wherein the cutting edge includes industrial abrasive material or particles.
